(19) United States
(12) Patent Application Publication
(10) Pub. No.: US 2011/0095662 A1
(43) Pub. Date: Apr. 28, 2011

(54) ELECTRONIC DEVICE ENCLOSURE

(75) Inventors: WEI-JUN WANG, Shenzhen City (CN); ZI-MING TANG, Shenzhen City (CN)

(73) Assignees: HONG FU JIN PRECISION INDUSTRY (ShenZhen)CO., LTD., Shenzhen City (CN); HON HAI PRECISION INDUSTRY CO., LTD., Tu-Cheng (TW)

(21) Appl. No.: 12/649,580

(22) Filed: Dec. 30, 2009

(30) Foreign Application Priority Data
Oct. 23, 2009 (CN) 200910308706.3

(51) Int. Cl. A47B 81/00; E05C 19/10

(52) U.S. Cl. 312/223.1; 292/116

(57) ABSTRACT

An electronic device enclosure includes a housing, a cover including latching portions, a locking member slidably assembled in the housing, an elastic member and an actuating member assembled in opposite ends of the housing adjacent to the locking member. The locking member includes engaging portions engaging with the latching portions of the cover, thus the cover is assembled on the housing. External force exerted on the actuating member pushes the locking member to compress the elastic member, thereby the engaging portions disengage from the latching portions, thus the cover is disassembled from the housing.

### BACKGROUND

1. Technical Field

The present disclosure relates to an enclosure for use with an electronic device.

2. Description of Related Art

Electronic devices, such as desktop computers, notebook computers, and digital video disc players are very popular and widely used. An electronic device generally includes an enclosure securing electronic components therein.

A commonly used electronic device enclosure includes a housing and a cover fixed thereon to cover an opening of the housing. The cover forms a plurality of latching hooks. The housing defines a plurality of latching steps corresponding to the latching hooks. The cover is fixed on the housing by application of external force on the cover until the latching hooks engage with the latching steps. However, considerable external force is necessary to detach the latching hooks from the latching steps to remove the cover from the housing, thus making disassembly difficult. Moreover, during disassembly, the latching hooks may be broken by using stronger applications of external force, thus damaging the electronic device enclosure.

Therefore, there is room for improvement within the art.

### BRIEF DESCRIPTION OF THE DRAWINGS

The components in the drawings are not necessarily drawn to scale, the emphasis instead being placed upon clearly illustrating the principles of the present disclosure. Moreover, in the drawings, like reference numerals designate corresponding parts throughout the several views, and all the views are schematic.

FIG. 1 is an isometric view of an embodiment of an electronic device enclosure, the electronic device enclosure including a housing and a cover.

FIG. 2 is an exploded, isometric view of the electronic device enclosure in FIG. 1.

FIG. 3 is an isometric view of the cover of the electronic device enclosure in FIG. 2.

FIG. 4 is a cross-sectional view of the electronic device enclosure, showing the cover being assembled to the housing.

FIG. 5 is an enlarged view of portion V in FIG. 4.

FIG. 6 is a cross-sectional view of the electronic device enclosure taken along line VI-VI in FIG. 1.

FIG. 7 is a cross-sectional view of the electronic device enclosure taken along line VII-VII in FIG. 1.

### DETAILED DESCRIPTION

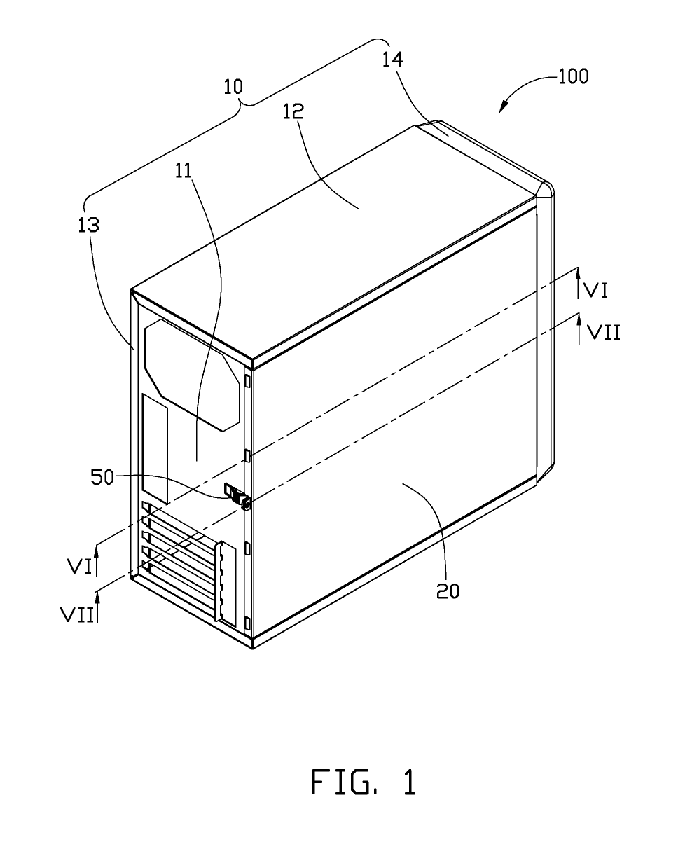

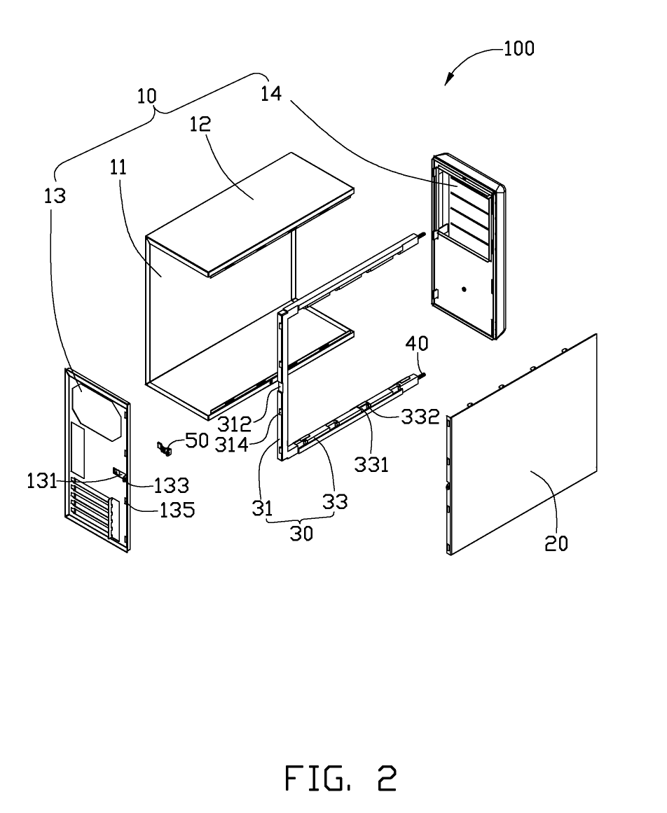

Referring to FIGS. 1 and 2, an embodiment of an electronic device enclosure 100 includes a housing 10, a cover 20 fixed on the housing 10, a locking member 30 slidably assembled in the housing 10, two elastic members 40, and an actuating member 50. The elastic members 40 and the actuating member 50 are assembled in opposite ends of the housing 10 adjacent to the locking member 30, and the locking member 30 is abutted between the elastic members 40 and the actuating member 50.

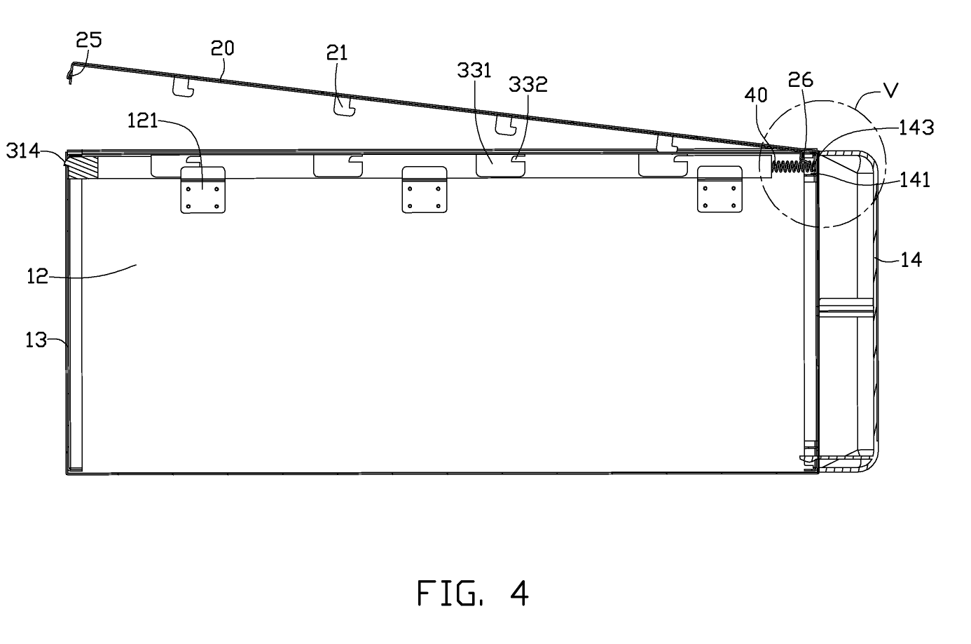

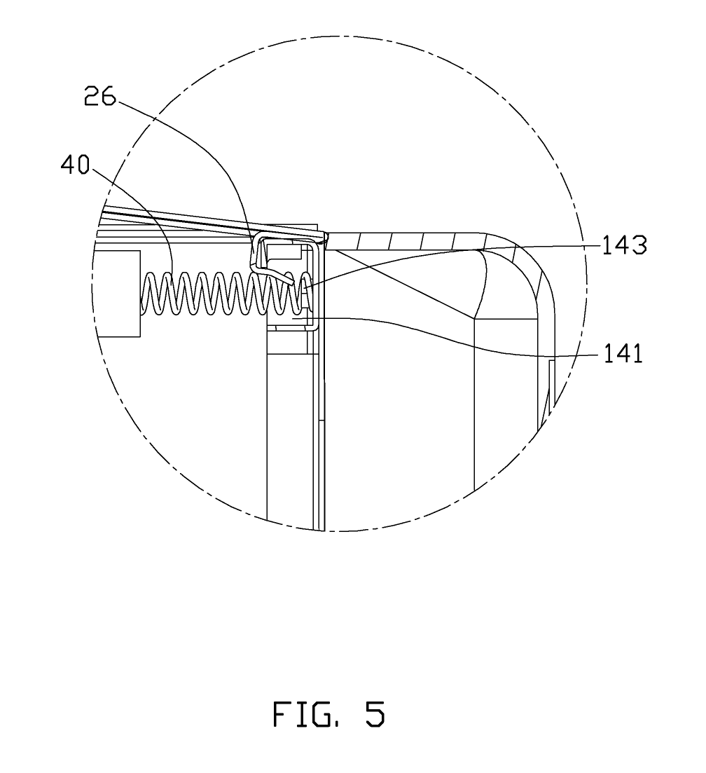

The housing 10 includes a rectangular base 11, two first sidewalls 12 extending substantially perpendicular from opposite ends of the rectangular base 11, a second sidewall 13 and a third sidewall 14 fixed on the rectangular base 11 and the first sidewalls 12. A plurality of fixing brackets 121 (shown in FIG. 4) are positioned on one end of each first sidewall 12 located away from the rectangular base 11. The locking member 30 can be placed on the fixing brackets 121, thus the locking member 30 can slide along the first sidewalls. The second sidewall 13 forms a first locking portion 133 extending on an outer surface, and defines an opening 131 adjacent to the first locking portion 133. The first locking portion 133 defines a through hole (not labeled) in the center. The second sidewall 13 also defines a plurality of latching holes 135 at opposite sides of the first locking portion 133. The actuating member 50 can abut the locking member 30 through the opening 131. The third sidewall 14 defines a positioning groove 141 (shown in FIG. 5) in an end, and forms two positioning post 143 (shown in FIG. 5) on the bottom surface of the positioning groove 141.

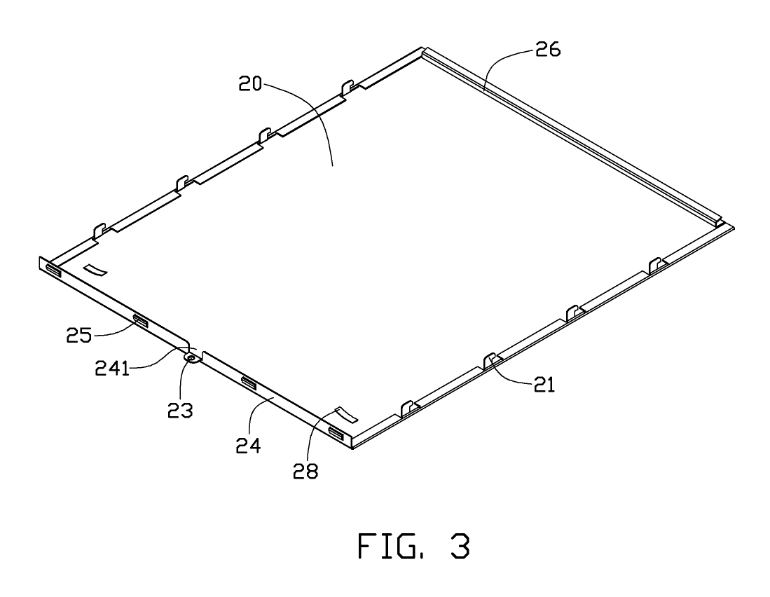

Referring to FIG. 3, the cover 20 may be a substantially rectangular plate. A plurality of latching portions 21 are formed on opposite ends of the cover 20. A bent portion 24 and a positioning portion 26 are formed on the other opposite ends of the cover 20. In the illustrated embodiment, the latching portions 21 are latching hooks. The positioning portion 26 may be a substantially elongate piece bent from one end of the cover 20. The bent portion 24 defines a notch 241 in the middle portion, and forms a second locking portion 23 adjacent to the notch 241. The second locking portion 23 defines a through hole (not labeled) in a center. The bent portion 24 also defines a plurality of latching grooves 25 adjacent to opposite sides of the notch 241. Two elastic pieces 28 are positioned on one end of the cover 20 which is adjacent to the bent portion 24.

Referring also to FIGS. 2 and 4, the locking member 30 is substantially C-shaped, and includes a base arm 31 and two side arms 33 extending substantially perpendicular from the two ends of the base arm 31. The base arm 31 defines a recess portion 312 in the middle section, and forms a plurality of latching protrusions 314 on opposite sides of the recess portion 312. Each side arm 33 defines a plurality of receiving grooves 331 for receiving the latching portions 21 of the cover 20. A side surface of each receiving groove 331 away from the base arm 31 forms an engaging portion 332 to engage with the corresponding latching portion 21. In the illustrated embodiment, the engaging portions 332 are engaging hooks.

The two elastic members 40 may be helical springs positioned in the positioning groove 141 of the housing 10, and an end of each elastic member 40 may be sleeved on the positioned post 143. Alternatively, the elastic members 40 may be in the form of spring washers, elastic rubber rings, or elastic cylinders.

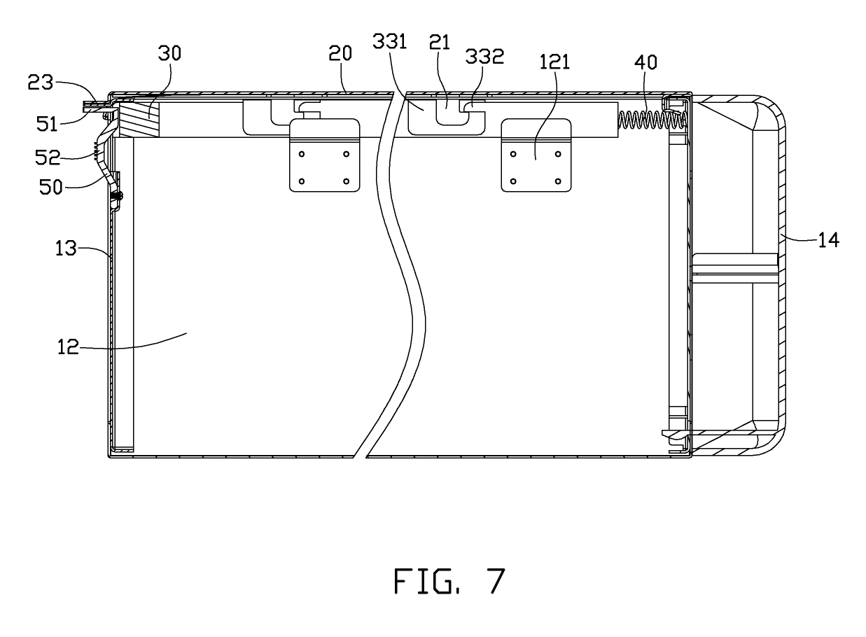

Referring to FIG. 7, the actuating member 50 may be a metal piece, and includes a third locking portion 51 extending from an end of the actuating member 50 and a pressing portion 52 formed at the middle section of the actuating member 50. The third locking portion 51 defines a through hole (not labeled) in a center. The pressing portion 52 forms a plurality of ribs (not labeled) to facilitate the use of the actuating member 50.

Referring to FIGS. 4, 6 and 7, during assembly of the electronic device enclosure 100, the locking member 30 is slidably assembled on the housing 10 by the fixing brackets 121 of the first sidewalls 12. An end of the elastic member 40 is sleeved on the positioning post 143, such that the elastic member 40 is positioned in the positioning groove 141 of the third sidewall 14. The actuating member 50 is positioned in the recess portion 312 of the locking member 30. The second sidewall 13 and the third sidewall 14 are fixed on opposite sides of the rectangular base 11. The third locking portion 51 of the actuating member 50 abuts the first locking portion 133 of the second sidewall 13. The pressing portion 52 of the actuating member 50 passes through the opening 131 of the second sidewall 13. The elastic members 40 abut the locking member 30, thus the latching protrusions 314 pass through the latching holes 135 of the second sidewall 13.

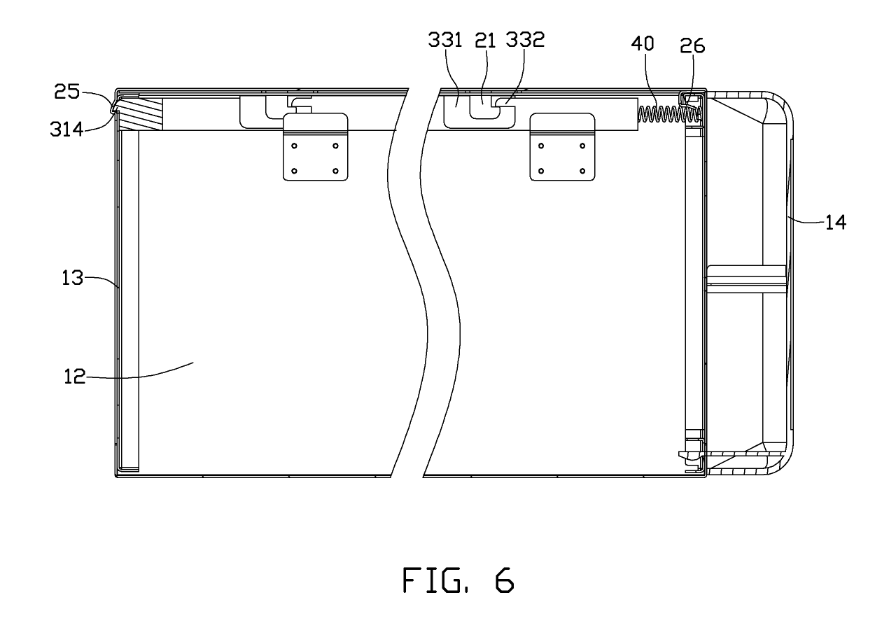

Referring also to FIGS. 3 and 6, during assembly of the cover 20 to the housing 10, force exerted on the pressing portion 52 moves the actuating member 50 to push the locking member 30 to compress the elastic members 40. The positioning portion 26 of the cover 20 is latched in the positioning groove 141 of the third sidewall 14. The latching portions 21 of the cover 20 are received in the receiving grooves 331 of the locking member 30. The second locking portion 23 of the cover 20 abuts the first locking portion 133 of the second sidewall 13. The elastic pieces 28 abut the base arm 31, in an elastically deformed state. Subsequently, when external force on the actuating member 50 is released, the locking member 30 moves towards the second sidewall 13 from elastic force generated by the elastic member 40. Thus, the engaging portions 332 engage with the latching portions 21, the latching protrusions 314 engage in the latching grooves 25, and the cover 20 is assembled on the housing 10.

The second locking portion 23 of the cover 20, the first locking portion 133 of the second sidewall 13, and the third locking portion 51 of the actuating member 50 may be fixed together by a fastening member, such as a screw, such that the cover 20 may be stably assembled on the housing 10.

During removal of the cover 20 from the housing 10, external force exerted on the pressing portion 52 pushes the locking member 30 to separate from the second sidewall 13, thereby the latching protrusions 314 disengage from the latching grooves 25 and the latching portions 21 disengage from the engaging portions 332. An end of the cover 20 adjacent to the second sidewall 13 withdraws by elastic force generated by the elastic pieces 28. Thus, the cover 20 can be easily disassembled from the housing 10.

In alternative embodiments, the locking member 30 may be substantially L shaped, in other words, the locking member 30 may include only one side arm 33. The cover 20 may form a plurality of latching portions 21 on one side. The latching portion 21 may be a latching tab defining a latching hole in an end to engage with the engaging portion 332. The engaging portion 332 may be an engaging groove defined in a side surface of the receiving groove 331 to engage with the latching portion 21.

It is believed that the present embodiments and their advantages will be understood from the foregoing description, and it will be apparent that various changes may be made thereto without departing from the spirit and scope of the disclosure or sacrificing all of its material advantages.

What is claimed is:

1. An electronic device enclosure, comprising:
a housing;
a cover comprising a plurality of latching portions; and
a locking member slidably assembled in the housing, the locking member comprising a plurality of engaging portions;
wherein the locking member slides relative to the housing to enable the plurality of engaging portions to engage with or disengage from the plurality of latching portions, thus the cover is assembled on or disassembled from the housing.

2. The electronic device enclosure of claim 1, further comprising an elastic member assembled in the housing to abut the locking member.

3. The electronic device enclosure of claim 2, further comprising an actuating member assembled in the housing adjacent to the locking member, wherein the actuating member is pressed to push the locking member to compress the elastic member.

4. The electronic device enclosure of claim 1, wherein the plurality of latching portions are formed on opposite sides of the cover; the locking member further comprises a base arm and two side arms extending substantially perpendicular from two ends of the base arm, each side arm defines a plurality of receiving grooves, the plurality of engaging portions are formed on the side surfaces of the receiving grooves.

5. The electronic device enclosure of claim 4, wherein the plurality of latching portions are latching hooks, the plurality of engaging portions are engaging hooks.

6. The electronic device enclosure of claim 4, wherein the housing defines a plurality of latching holes in a second sidewall; the base arm of the locking member forms a plurality of latching protrusions passing through the plurality of latching holes; the cover further comprises a bent portion defining a plurality latching grooves to latch with the plurality of latching protrusions.

7. The electronic device enclosure of claim 2, wherein the housing defines a positioning groove and forms a positioning post on the bottom surface of the positioning groove; the elastic member is sleeved on the positioning post, thus the elastic member is positioned in the positioning groove.

8. The electronic device enclosure of claim 7, wherein the cover forms a positioning portion on an end, the positioning portion is latched in the positioning groove of the housing.

9. The electronic device enclosure of claim 3, wherein the locking member defines a recess portion to receive the actuating member; the housing defines an opening in a second sidewall, the actuating member comprises a pressing portion passing through the opening.

10. The electronic device enclosure of claim 9, wherein the housing forms a first locking portion adjacent to the opening; the actuating member forms a third locking portion abutting on a first side surface of the first locking portion of the housing; the cover forms a second locking portion abutting on a second side surface of the first locking portion of the housing.

11. The electronic device enclosure of claim 1, wherein the cover further comprises an elastic piece positioned on an end thereof, the elastic piece abuts the locking member.

12. An electronic device enclosure, comprising:
a housing;
a cover comprising a plurality of latching portions;
a locking member slidably assembled in the housing, the locking member comprising a plurality of engaging portions;
an elastic member and an actuating member assembled in opposite ends of the housing adjacent to the locking member;
wherein the plurality of engaging portions engage with the plurality of latching portions, thus the cover is assembled on the housing; when the actuating member is pressed to push the locking member to compress the elastic member, the plurality of engaging portions disengage from the plurality of latching portions, thus the cover is disassembled from the housing.

13. The electronic device enclosure of claim 12, wherein the plurality of latching portions are formed on opposite sides of the cover; the locking member further comprises a base arm and two side arms extending substantially perpendicular from two ends of the base arm, each side arm defines a plurality of receiving grooves, and the plurality of engaging portions are formed on the side surfaces of the receiving grooves.

14. The electronic device enclosure of claim 13, wherein the plurality of latching portions comprises latching hooks, and the plurality of engaging portions are engaging hooks.

15. The electronic device enclosure of claim 13, wherein the housing defines a plurality of latching holes in a second sidewall; the base arm of the locking member forms a plurality of latching protrusions passing through the plurality of latching holes; and the cover further comprises a bent portion defining a plurality of latching grooves to latch with the plurality of latching protrusions.

16. The electronic device enclosure of claim 12, wherein the housing defines a positioning groove and forms a positioning post on the bottom surface of the positioning groove; the elastic member is sleeved on the positioning post, thus the elastic member is positioned in the positioning groove.

17. The electronic device enclosure of claim 16, wherein the cover forms a positioning portion on an end, the positioning portion is latched in the positioning groove of the housing.

18. The electronic device enclosure of claim 12, wherein the locking member defines a recess portion to receive the actuating member; the housing defines an opening in a second sidewall, the actuating member comprises a pressing portion passing through the opening.

19. The electronic device enclosure of claim 18, wherein the housing forms a first locking portion adjacent to the opening; the actuating member forms a third locking portion abutting on a first side surface of the first locking portion of the housing; the cover forms a second locking portion abutting on a second side surface of the first locking portion of the housing.

20. The electronic device enclosure of claim 12, wherein the cover further comprises an elastic piece positioned on an end thereof, the elastic piece abuts the locking member.
